(19) United States
(12) Patent Application Publication
(10) Pub. No.: US 2015/0050507 A1
(43) Pub. Date: Feb. 19, 2015

(54) JOINING OF POLYMER AND SURFACE-MODIFIED METAL BY LASER WELDING

(71) Applicants: Aarhus Universitet, Aarhus C (DK); Force Technology, Brandby (DK)

(72) Inventors: Mogens Hinge, Terndrup (DK); Jens Klæstrup Kristensen, Farum (DK); Kim Daasbjerg, Skanderborg (DK); Steen Uttrup Pedersen, Lystrup (DK); Marianne Strange, Frederikssund (DK); Steen-Erik Nielsen, Hillerød (DK)

(73) Assignees: Aarhus Universitet, Nordre Ringgade (DK); Force Technology, Brondby (DK)

(21) Appl. No.: 14/386,195

(22) PCT Filed: Mar. 18, 2013
(86) PCT No.: PCT/DK2013/050076

§ 371 Date: Sep. 18, 2014

(30) Foreign Application Priority Data
Mar. 21, 2012 (DK) PA 2012 70128

(51) Int. Cl. B23K 26/20; B32B 15/082; B32B 7/12; C25D 9/02

(52) U.S. Cl. CPC B23K 26/203; C25D 9/02; B32B 15/082; B32B 7/12; B32B 2250/02; B32B 2255/06; B32B 2255/26; B32B 2311/30; B32B 2333/12; B32B 2457/00; B32B 2535/00; B32B 2605/08
USPC 428/463; 156/272.8; 156/151

(57) ABSTRACT

The present invention relates to a method of joining a metal part 1 and a non-liquid polymer part 2. The first step of the method is to attach a primer 4 to a metal surface 3 of the metal part 1. The primer 4 is then polymerized so that the metal surface 3 is at least partly covered with surface immobilized polymer brushes 5. Then the metal surface 3 with the polymer brushes 5 is brought into contact with a polymer surface of the polymer part 2, so that an interface is obtained comprising the metal surface 3, the primer 4, the polymer brushes 5 and the polymer surface. Finally, the interface is heated by use of laser welding until the polymer brushes 5 and a part of the polymer part 2 melt or soften and mix to such an extent that the metal part 1 and the polymer part 2 remain joined after cooling. The welding may e.g. be performed so that so that welding seams are obtained along equidistant lines across the surface.

### FIELD OF THE INVENTION

The present invention relates to joining of a surface-modified metal part and a non-liquid polymer part.

### BACKGROUND OF THE INVENTION

Joining of metal and polymer parts are relevant in a number of industrial applications, such as within automotive, electronics and medico technologies.

Metal and polymer parts are today typically joined either by mechanical joining or by adhesion. In often used adhesive methods, a glue is first applied to one or both of the two components to be joined. They are then pressed together to form the completed joint. However, as generally only weak interatomic forces (physisorption) come into play, suitable adhesives are commonly associated with long curing times, sensitivity to ambient conditions, such as humidity and temperature, and the need for extensive surface pre-treatment, such as plasma treatment. Furthermore, the layer of adhesive fills a gap between the components to be joined, and this additional thickness is undesirable for some applications. A number of potential applications are also faced with the challenge that the adhesion between metals and polymers is generally weak. Such interfaces are furthermore prone to degradation over time when exposed to various environmental factors as e.g humidity and elevated temperatures. Hence, breakage at the interface easily occurs, resulting in delamination which for industrial use, as highlighted by the medico industry, is totally unacceptable.

US 2003/0135197 discloses a method of joining metal and polymer surfaces for medical devices by use of coupling agents. The coupling agents contain at least two sets of functional groups having a bonding affinity with organic compounds and inorganic compounds, respectively. Preferred coupling agents possess first functional groups that form covalent bonds with a polymeric material, whereas the second functional groups form ionic bonds with a metal, such as stainless steel. The coupling agents can be used with or without the use of thermal activation.

The process is thus a special kind of adhesive bonding using an advanced bonding agent, and as such it has many of the problems discussed above.

Hence, an improved method of joining a metal part and a polymer part would be advantageous, and in particular a more efficient method that can also be used for material combinations that are not otherwise easy to join would be advantageous.

### OBJECT OF THE INVENTION

It is an object of the present invention to provide a method that generates strong durable, preferably covalent, bonds between a metal part and a polymer part that may otherwise be incompatible.

It is another object of the present invention to provide a method that is faster, cleaner and more resistant to environmentally facilitated degradation than known adhesive methods of industrial relevance.

It is another object of the present invention to provide a method with which complex three-dimensional parts can be joined at pre-determined positions while leaving other positions un-joined.

It is an object of at least some embodiments of the invention to provide a method which takes place at temperatures that do not degrade the polymer surface.

It is a further object of the present invention to provide an alternative to the prior art.

### SUMMARY OF THE INVENTION

Thus, the above described object and several other objects are intended to be obtained in a first aspect of the invention by providing a method of joining a metal part and a non-liquid polymer part, the method comprising the steps of:
attaching a primer to a metal surface of the metal part,
polymerizing the primer so that the metal surface is at least partly covered with surface immobilized polymer brushes,
bringing the metal surface with the polymer brushes into contact with a polymer surface of the polymer part, so that an interface is obtained comprising the metal surface, the primer, the polymer brushes and the polymer surface, and
subsequently heating the interface by use of laser welding until the polymer brushes and a part of the polymer part melt or soften and mix to such an extent that the metal part and the polymer part remain joined after cooling.

By such a method, only the materials to be joined are involved in the joining. The result is a more clean process than what is e.g. the case when a metal and a polymer part are joined by gluing.

The heating may be applied by focused and thus localized laser light, continuous wave (CW) or pulsed mode. Hereby complex and three-dimensional parts can be joined at pre-determined positions while leaving other positions un-joined. Furthermore, it may be advantageous that the metal surface and the polymer surface are pressed together during heating to ensure a good interfacial mixing.

The amount of heating applied and thus temperatures reached should preferably be so low that degradation of the polymer brushes and the polymer part is avoided.

The primer is preferably attached to the metal surface by covalent bonds so that a strong chemical bonding is obtained. The actual bonding obtained will be a question of chemistry, and the control thereof will be well known to a person skilled in the art.

The primer may be attached to the metal surface by electrochemical grafting. In some embodiments of the invention, the metal surface is electrochemically activated while the primer is attached. Hereby a covalent bonding to the surface can be obtained.

In preferred embodiments of the invention, the polymerizing step has a duration resulting in a predefined average length and/or average density of the polymer brushes. Hereby the surface properties and thereby also the resulting bonding can be optimized and controlled for a given combination of materials.

The welding may be done by near-infrared (NIR) laser welding. For most polymers, this laser light has a wave length which is transparent to the bulk polymer so that it may be focused on the metal surface. Hereby it can be ensured that the energy is dissipated at the interface for the melting or softening of the interfacial polymers.

An infrared (IR) absorber may be added or attached to the polymer brushes before heat is applied. Such an absorber may be used to absorb the energy from the laser light at predetermined positions, so that a stronger bonding and/or a faster process is obtained without damage to the surrounding material.

In some embodiments of the invention, the primer is the same type of polymer as the polymer part. Hereby a good mixing between the polymer brushes and the polymer chains of the melted or softened bulk polymer may be ensured, whereby the strong bonding can be obtained.

The polymer part may be made from polymethylmethacrylate (PMMA), and the metal part may be made from nickel, platinum, gold or steel alloys, such as stainless steel.

A second aspect of the invention relates to an item comprising a metal and a polymer part which have been joined by a method according to the present invention. The first and second aspect of the present invention may each be combined. These and other aspects of the invention will be apparent from and elucidated with reference to the embodiments described hereinafter.

### BRIEF DESCRIPTION OF THE FIGURES

The method of according to the invention will now be described in more detail with regard to the accompanying figures. The figures show one way of implementing the present invention and is not to be construed as being limiting to other possible embodiments falling within the scope of the attached claim set.

FIG. 1 shows schematically a metal part and a polymer part to be joined by a method according to the present invention.

FIG. 2 shows schematically how a primer is attached to the steel part.

FIG. 3 shows schematically the polymer brushes attached the metal surface as well as the polymerization of the polymer brushes.

FIG. 4 shows schematically the steps in the joining of the metal part and the polymer part.

FIG. 5.a shows schematically the welding process, and FIGS. 5.b and 5.c show schematically a cross sectional view of the metal part and the polymer part before and after the welding is performed, respectively.

FIG. 6 shows results of preliminary tests in which PMMA brushes have been polymerized onto an AISI 316 stainless steel surface and then laser welded to a sheet of transparent PMMA in an overlap joint.

### DETAILED DESCRIPTION OF AN EMBODIMENT

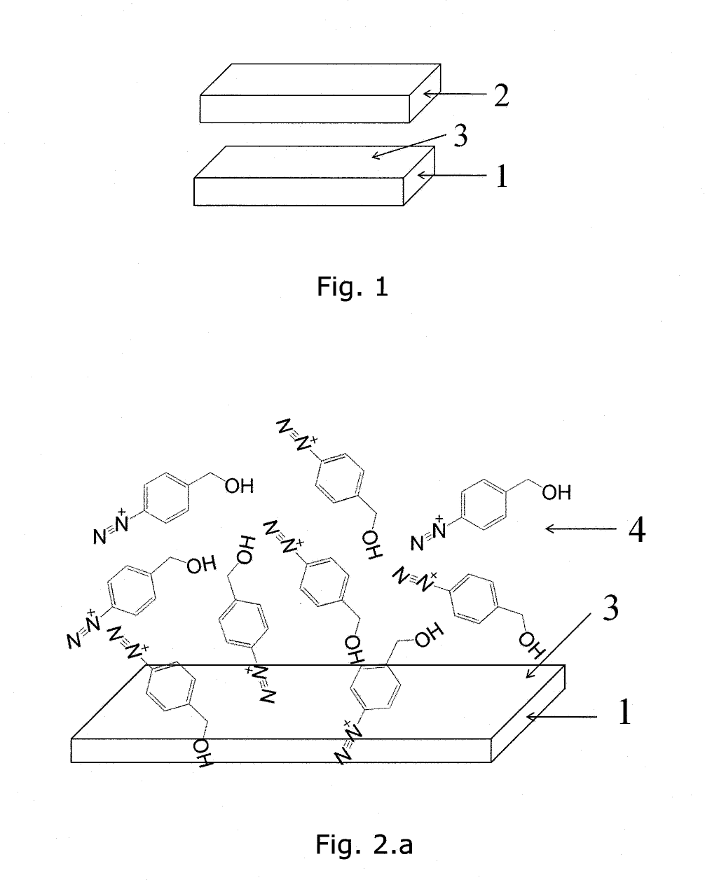

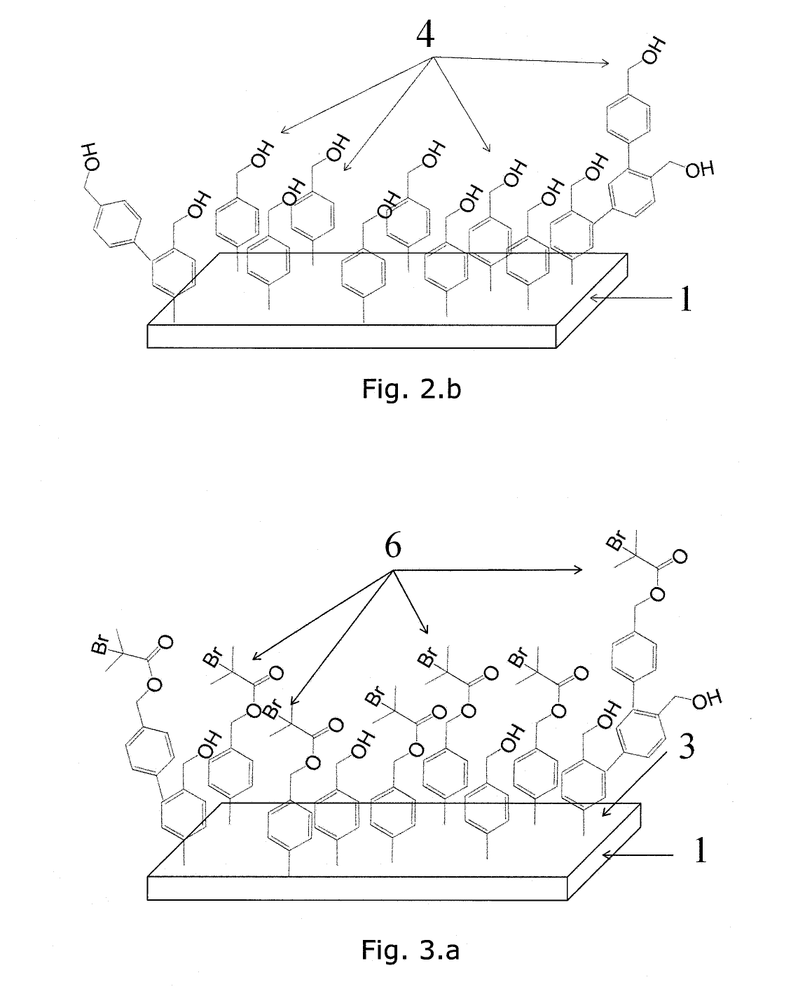

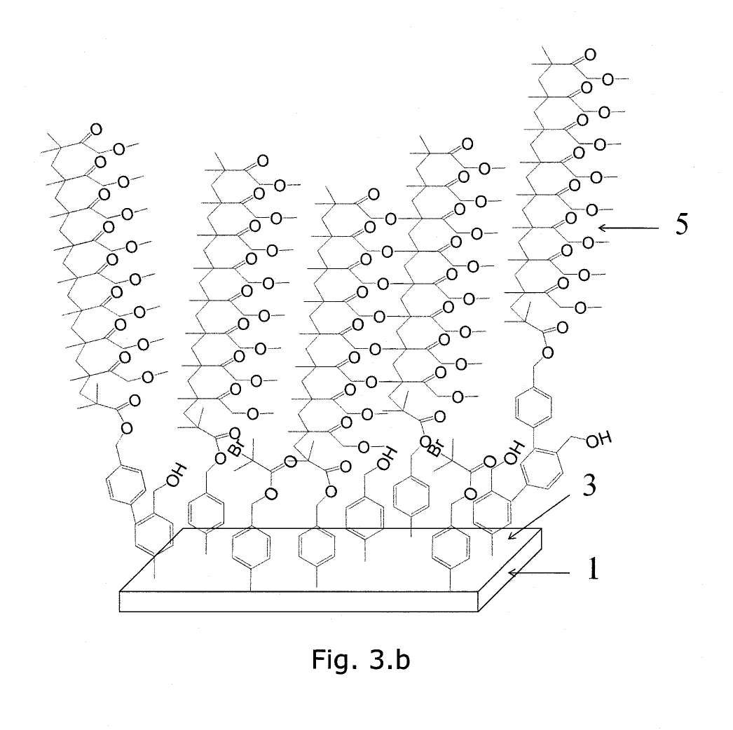

The present invention relates to a method which can be used to join a metal part 1 and a non-liquid polymer part 2 as shown schematically in FIG. 1. As an early step in the joining process, a metal surface 3 of the metal part 1 is modified as will be described in the following. The parts 1,2 may e.g. be made from stainless steel and PMMA respectively, and typical applications may be found in the automotive, medico, toy, apparatus or construction industry. The method is particularly advantageous for applications where it is inappropriate to use mechanical joining or joining by gluing. The method is illustrated schematically in FIGS. 2-4. FIG. 2 shows the first step in which a reactive primer 4 is attached to a metal surface 3 of the metal part 1. FIG. 2.a shows the primer 4 being present above the metal surface 3, and FIG. 2.b shows the situation where the primer 4 has been attached. In preferred embodiments of the invention, the primer 4 is attached to the metal surface 3 by covalent bonds so that a strong chemical bonding is obtained. This is typically done by electrochemical grafting according to procedures which will be well known to a person skilled in the art. For some metals, such as stainless steel, the covalent bond formation can be greatly enhanced if the metal surface 3 is concomitantly electrochemically activated. The primer design is of utmost importance as it serves as basis for an initiator 6 in the subsequent polymerization process to form the tethered polymer chains also referred to as polymer brushes 5; this is shown schematically in FIG. 3. Attachment of the initiator 6 can e.g. be achieved through different pathways such as silane, diazonium and thiol chemistry or by attaching a precursor that is subsequently modified into an active initiator.

FIG. 3.a shows the initiator 6 and 3.b shows the length of the polymer brushes 5 after a longer duration of the polymerization step. The polymerization results in the metal surface 3 being covered with surface immobilized polymer brushes 5. In FIG. 3, the whole metal surface 3 is covered with the polymer brushes 5, but it may also be possible to cover only part of the metal surface 3 if desired. This can e.g. be done by SECM, partial submersion or lithographical methods.

The polymerizing step has a duration resulting in a predefined average length of the polymer brushes 5. The actual process parameters to use for a given application can be determined by experimentation, possibly assisted by computer simulations.

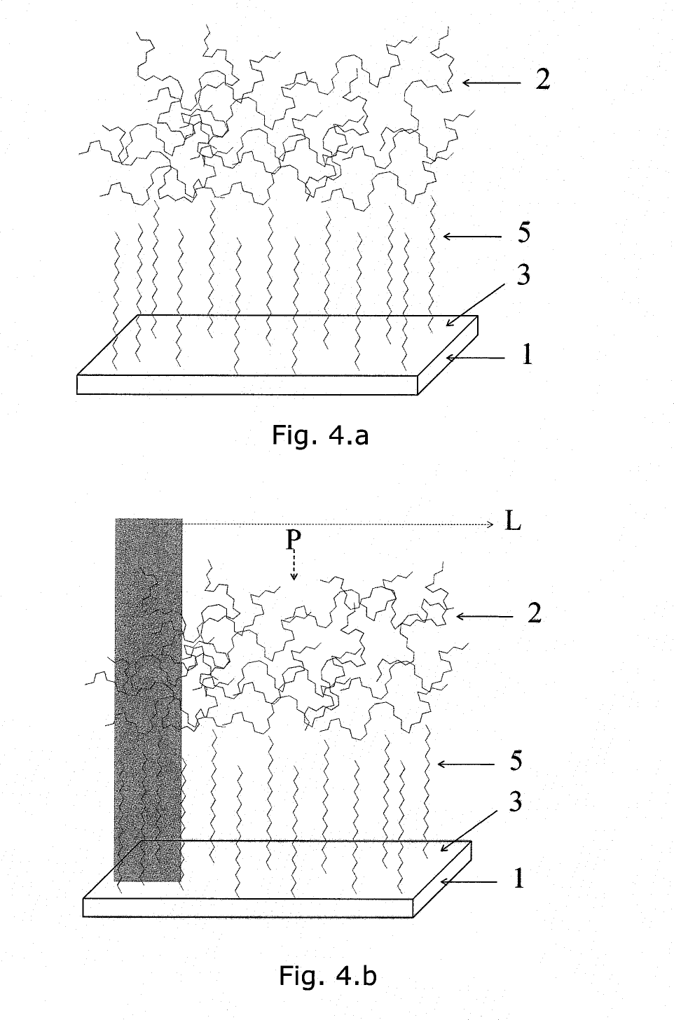

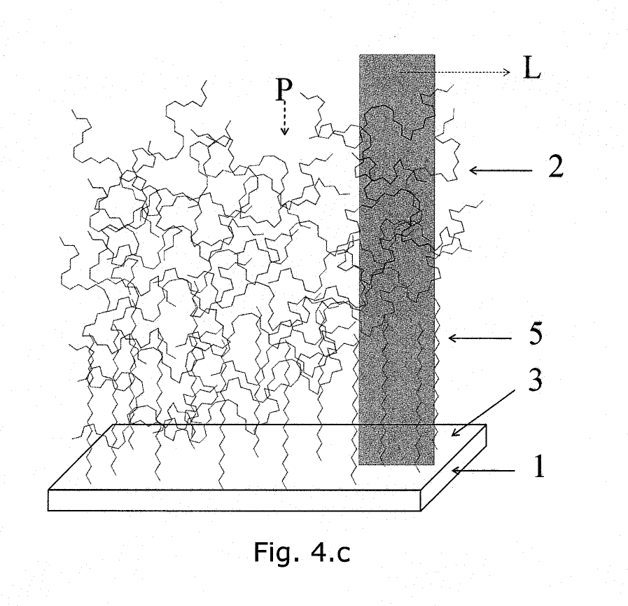

The polymer brushes 5, now covalently attached to the metal surface 3, are then brought into contact with the polymer part 2 so that an interface is obtained comprising the metal surface 3, the primer 4, the polymer brushes 5 and the polymer surface facing the metal surface 3. This is shown schematically in FIG. 4.a where the non-liquid polymer is now illustrated schematically by the polymer chains constituting the polymer part 2. Furthermore, a pressure P is typically, but not necessarily, applied to obtain a good contact between the metal and polymer surfaces. Such a pressure is shown schematically in FIG. 4.b.

The interface is then heated until the polymer brushes 5 and a part of the polymer part 2 melt or soften and mix to such an extent that the metal part 1 and the polymer part 2 remain joined after cooling.

The heating is applied by laser welding, e.g. by application of precise and focused laser beam (possibly pulsed), until the polymer brushes 5 and the bulk polymer at the interface melt or soften and mix. The application of the laser pulses is shown schematically in FIGS. 4.b and 4.c and indicated by L. The grey area in the figure illustrates the laser beam which is moved across the surface as indicated by the arrow and the two positions in FIGS. 4.b and 4.c, respectively. In some embodiments of the invention, the welding is done by near-infrared (NIR) laser welding. However, any laser welding method resulting in a localized heating at the interface is considered to be covered by the present invention.

Optimized laser welding process parameters for a given combination of materials can e.g. be determined by experiments using systematic variations in pressure and temperature with time. In addition, different laser sources and thereby different wavelengths, power levels, continuous wave (CW) or pulsed mode may be used; relevant sources include Nd-YAG-, fibre-, disc- and the diode lasers, but other laser sources may also be relevant.

Some parameters of interest for a given optimization of the bonding strength are the brush density, the molecular weight of the brushes 5 and the time-temperature-pressure processing route of the laser welding process. In order to access these parameters, a development of a synthetic route for controlling the initiator concentration on the metal surface 3 has to be achieved together with a careful optimisation of the welding process variables. The necessary information about the surface properties can e.g. be obtained by combining different surface sensitive techniques such as Polarization Modulated Infrared Reflection Absorption Spectroscopy (PMIRRAS), ellipsometry, contact angle measurements, quartz crystal microbalance (QCM), and Atomic Force Microscopy (AFM).

It is considered possible to optimize the bonding between two specific types of metal and polymer by aiming at a specific chain distribution profile of the polymer brushes 5 at the interface. The controlled surface densities of the polymer brushes 5 may e.g. be achieved by first grafting the metal surface 3 by electrochemical reduction of an aminyl or a hydroxyl functionalized benzenediazonium salt. Subsequently, an atom-transfer-radical-polymerization (ATRP) initiator 6 can be attached by amidation or esterification in wet chemistry. Preliminary results show that it is possible to obtain a dense layer of active ATRP initiators.

Experiments performed in relation to the present invention have shown that it is possible to obtain a very fine control of the layer thickness of the polymer brushes 5 by employing the ATRP polymerization method for grafted initiators 6 bound to the surface 3 of stainless steel.

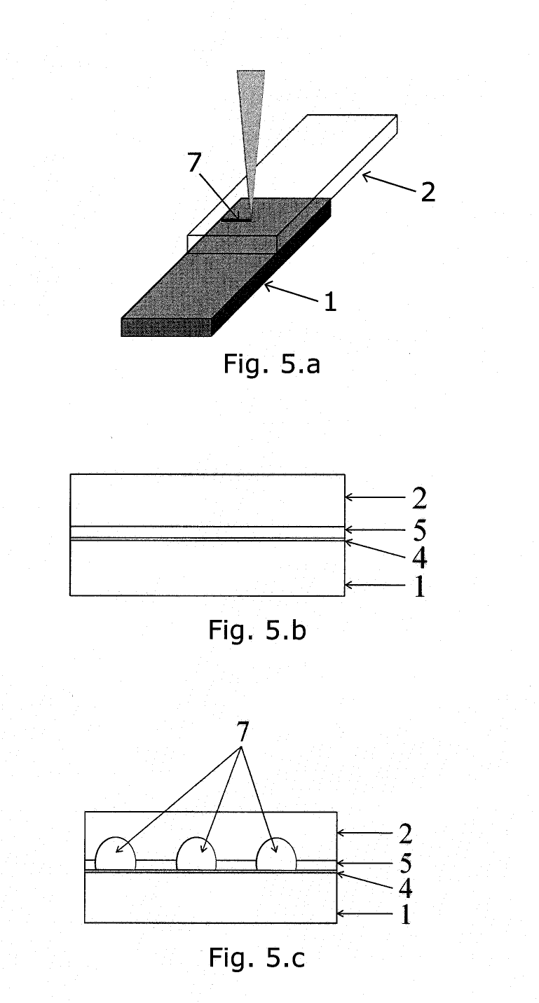

FIG. 5.a shows schematically a welding process wherein the laser is moved along a linear path across the metal part 1 and the polymer part 2 to be joined. FIGS. 5.b and 5.c show schematically cross sectional views of the metal part 1 and the polymer part 2 before and after the welding is performed, respectively. In this example the welding is done so that welding seams 7 are obtained along equidistant lines across the interface. It is also possible to perform the welding e.g. in two or more directions or across over the full interface if desired. In the welding seams 7 and possibly also in the areas between the welding seams 7, the polymer brushes 5 and polymer chains in the polymer part 2 are mixed and entangled to form a strong bonding.

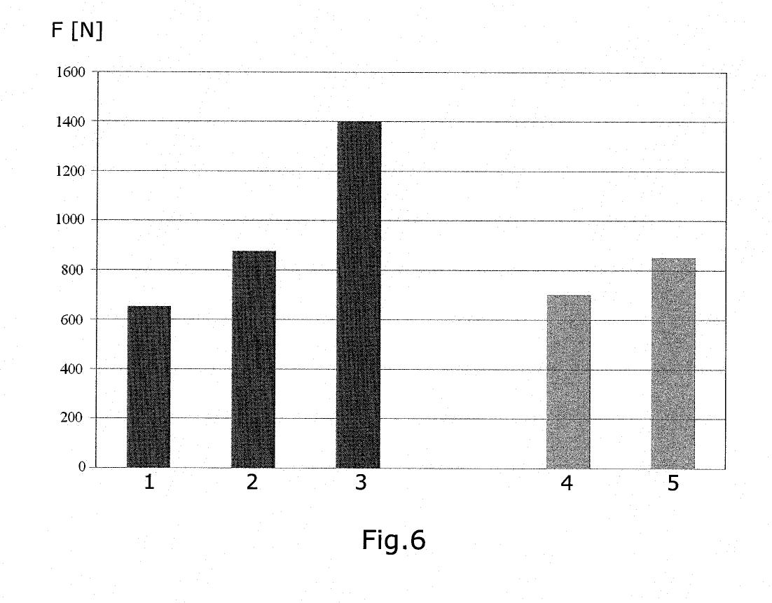

FIG. 6 shows results of preliminary tests in which PMMA brushes have been polymerized onto an AISI 316 stainless steel surface and then laser welded to a sheet of transparent PMMA in an overlap joint. The welding parameters used were 50 W laser power focused to a spot diameter of approximately 1 mm and a welding speed of 500 mm/min corresponding to a line energy of 6 J/mm (not corrected for energy efficiency). The binding width was approximately 2.5 mm, and the tensile fracture force of the welded specimens is shown along the y-axis. The first three columns (1, 2 and 3) show the fracture force F for specimens where the steel had been coated with polymer brushes for 2, 6 and 8 hours respectively before being joined with the PMMA plate. The specimens which had been coated for 2 and 6 hours broke at the interface. The specimen which had been coated for 8 hours broke in the transparent PMMA whereas the interface between steel and PMMA plate was intact. The results show that there seems to be a correlation between polymerization times and brush length on one hand and weld tensile strength on the other hand. The two right columns (4 and 5) show reference measurements made in the form of transparent PMMA laser welded to black and therefore light absorbing PMMA. They both broke in the black PMMA with the interface intact. The results therefore indicate that it is possible to obtain strengths of the joints between metal and polymer in the order of the strength of the polymer itself.

Although the present invention has been described in connection with the specified embodiments, it should not be construed as being in any way limited to the presented examples. E.g. the method can also be used for joining of other materials than those specifically mentioned. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method of joining a metal part and a non-liquid polymer part, the method comprising:
attaching a primer to a metal surface of the metal part,
polymerizing the primer so that the metal surface is at least partly covered with surface immobilized polymer brushes,
bringing the metal surface with the polymer brushes into contact with a polymer surface of the polymer part, so that an interface is obtained comprising the metal surface the primer the polymer brushes and the polymer surface, and
subsequently heating the interface by use of laser welding until the polymer brushes and a part of the polymer part melt or soften and mix such that the metal part and the polymer part remain joined after cooling.

2-11. (canceled)

12. The method according to claim 1, wherein the primer is attached to the metal surface by covalent bonds.

13. The method according to claim 12, wherein the primer is attached to the metal surface by electrochemical grafting.

14. The method according to claim 13, wherein the metal surface is electrochemically activated while the primer is attached.

15. The method according to claim 1, wherein the polymerizing step has a duration resulting in a predefined average length and/or average density of the polymer brushes.

16. The method according to claim 1, wherein the welding is done by near-infrared (NIR) laser welding.

17. The method according to claim 16, wherein an infrared (IR) absorber is added or attached to the polymer brushes before heat is applied.

18. The method according to claim 1, wherein the primer is the same type of polymer as the polymer part.

19. The method according to claim 1, wherein the polymer part is made from polymethylmethacrylate (PMMA).

20. The method according to claim 1, wherein the metal part is made from nickel, platinum, gold, steel, or stainless steel.

21. An item comprising a metal part and a polymer part, which have been joined by a method according to claim 1.
